(19) United States
(12) Patent Application Publication
(10) Pub. No.: US 2026/0369932 A1
(43) Pub. Date: Nov. 19, 2026

(54) CONNECTOR

(71) Applicant: YURA CO., LTD., Hwaseong-si (KR)

(72) Inventor: Chi Bong HA, Yongin-si (KR)

(21) Appl. No.: 19/144,013

(22) PCT Filed: Jan. 2, 2024
(86) PCT No.: PCT/KR2024/000039

§ 371 Date: Jun. 27, 2025

(30) Foreign Application Priority Data
Dec. 30, 2022 (KR) 10-2022-0190302

(51) Int. Cl. H01R 13/639; H01R 13/629

(52) U.S. Cl. CPC H01R 13/639; H01R 13/62933

(57) ABSTRACT

According to an embodiment of the present invention, a connector comprises: a first connector in which a first terminal is installed inside; a second connector in which a second terminal electrically connected to the first terminal is installed inside; and a fastening lever movably installed on the outer side of the second connector to guide complete fastening with the first connector, wherein the second connector includes a second connector body in which a locking portion is formed on the outer side and the second terminal is received on the inner side, and a locking member that is temporarily fixed to the locking portion, and that is moved to be latched and fixed to the first connector when the fastening lever is moved and the first and second connectors are completely fastened, thereby preventing separation of the second connector, so that enhanced coupling force is provided, improving the durability and reliability of the product.

### DESCRIPTION

### Field of the Invention

The present invention relates to a connector, and more specifically, to a connector that relays electrical signals via internal terminal connections.

### Background Art

Various electrical components are installed in vehicles, and connectors are used to supply power to them; with the recent spread of electric vehicles and the increase in additional functions of automobiles, high-voltage electricity has been supplied through connectors.

Accordingly, if the connector is inadvertently disconnected, it affects the supply of power to the vehicle's power source in the case of an electric vehicle and directly impacts the driver's safety, and a locking member that prevents disconnection of the connector is generally used to prevent the increased possibility of additional accidents caused by high voltage.

However, when the locking member is additionally fixed after the connector is fastened, there was a problem in that the insertion force increased, causing increased fatigue for the worker, and another problem in that the coupling force of the connector decreased because it was not possible to confirm whether the locking member was properly fastened.

### SUMMARY OF THE INVENTION

### Problem

An embodiment of the present invention has been devised to solve the above problems, and aims to provide a connector that reduces the insertion force of the locking member while achieving more stable coupling force.

### Solution

According to an embodiment of the present invention, a connector comprises a first connector in which a first terminal is installed inside; a second connector in which a second terminal electrically connected to the first terminal is installed inside; and a fastening lever movably installed on the outer side of the second connector to guide complete fastening with the first connector, wherein the second connector includes a second connector body in which a locking portion is formed on the outer side and the second terminal is received on the inner side, and a locking member that is temporarily fixed to the locking portion, and that is moved to be latched and fixed to the first connector when the fastening lever is moved and the first and second connectors are completely fastened, thereby preventing separation of the second connector.

The locking portion includes a movable space opened inward in the coupling direction and first and second temporary fixing portions having inclined surfaces in different directions, and the locking member includes a first locking rib that is latched and fixed to the first temporary fixing portion and latched and fixed on one side in the coupling direction, and a second locking rib that is latched and fixed to the second temporary fixing portion and latched and fixed on the other side in the coupling direction, the second locking rib having, at its distal end, an interlocking portion that is released from the second temporary fixing portion by a prevention projection formed on the first connector, moves to the other side in the coupling direction within the movable space, and is latched and fixed on one side of the prevention projection in the coupling direction.

The second locking rib is formed such that its distal end is exposed to the outside of the locking portion while being latched and fixed to the prevention projection.

The second connector body further includes a guide line into which the prevention projection is inserted in correspondence with the position of the second temporary fixing portion, and as the first and second connectors are fastened, the interlocking portion is elastically deformed along the outer surface of the prevention projection and released from the second temporary fixing portion.

The locking portion includes the first temporary fixing portion formed on the inner side and further includes a deformation support portion with slit lines formed on both sides, and the locking member includes a deformation inducing portion, which, when the locking member is inserted into the movable space, elastically deforms the deformation support portion in the axial direction and tightly fixes it to the fastening lever.

The second locking rib includes a second locking body, a guide projection protruding from one side of the second locking body and moving along the slit line, a second fixing projection protruding from the other side of the second locking body and latched and fixed to the second temporary fixing portion, and an interlocking portion, all of which are sequentially formed.

### Effect

As described above, according to the solutions of the present invention, various effects including the following can be expected. However, the present invention is not established only when all of the following effects are exhibited.

The connector of the present invention includes the locking portion formed on the second connector body, to which the locking member is latched and fixed, thereby allowing more stable coupling of the first and second connectors and ensuring stable electrical connection.

In addition, by forming slit lines in the locking portion and configuring the second locking rib to be released by the prevention projection formed on the first connector, the insertion force of the locking member is reduced, thereby decreasing worker fatigue and improving product productivity.

In addition, as the locking member is completely fastened to the locking portion, the locking portion and the fastening lever are latched and fixed to each other, thereby reinforcing the coupling force of the first and second connectors and ultimately improving the durability and reliability of the product.

### BRIEF DESCRIPTION OF THE DRAWINGS

FIG. 1 is a perspective view of a connector according to an embodiment of the present invention.

FIG. 2 is an exploded perspective view of FIG. 1.

FIG. 3(a) is an enlarged view of part A in FIG. 2, and FIG. 3(b) is a perspective view of FIG. 3(a) from another direction.

FIG. 4(a) is a perspective view of the locking member in FIG. 2 from another direction, and FIG. 4(b) is a further perspective view of FIG. 4(a).

FIG. 5(a) is a cross-sectional view taken along line Va-Va in a state where the locking member in FIG. 2 is temporarily fixed to a second connector, and FIG. 5(b) is a cross-sectional view taken along line Vb-Vb in a state where the locking member in FIG. 2 is temporarily fixed to the second connector.

FIG. 6(a) is a cross-sectional view taken along line VIa-VIa of FIG. 1, and FIG. 6(b) is a cross-sectional view taken along line VIb-VIb of FIG. 1.

FIG. 7 is a diagram illustrating the process in which FIG. 4(b) changes to FIG. 5(b) as the first and second connectors in FIG. 2 are coupled.

FIG. 8 is a perspective view showing the connector of FIG. 1 in a state coupled to a vehicle body.

### DETAILED DESCRIPTION OF THE PREFERRED EMBODIMENTS

Hereinafter, specific embodiments of the present invention will be described in detail with reference to the figures. However, descriptions of well-known functions or configurations are omitted so as not to obscure the gist of the present invention.

Additionally, for convenience of explanation, the direction in which the first and second connectors are coupled is defined as the coupling direction; the direction in which the second connector is formed is defined as the front in the coupling direction, and the direction in which the first connector is formed is defined as the rear in the coupling direction; and the direction in which the locking portion and the fastening lever come into contact is defined as the axial direction.

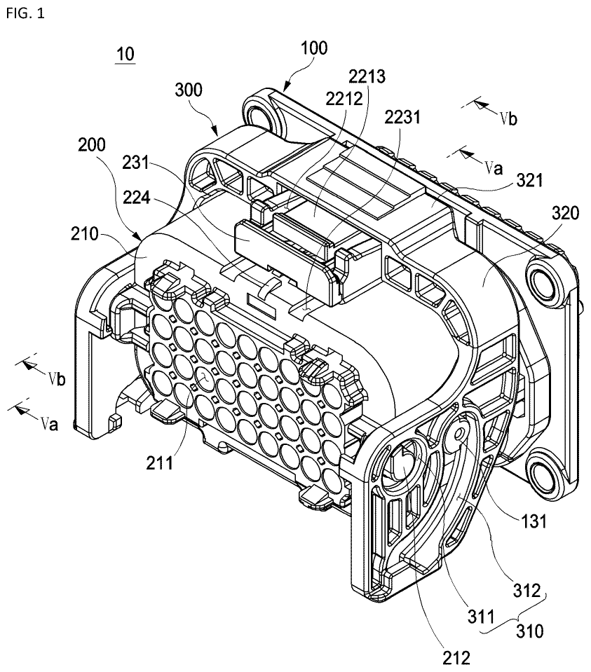

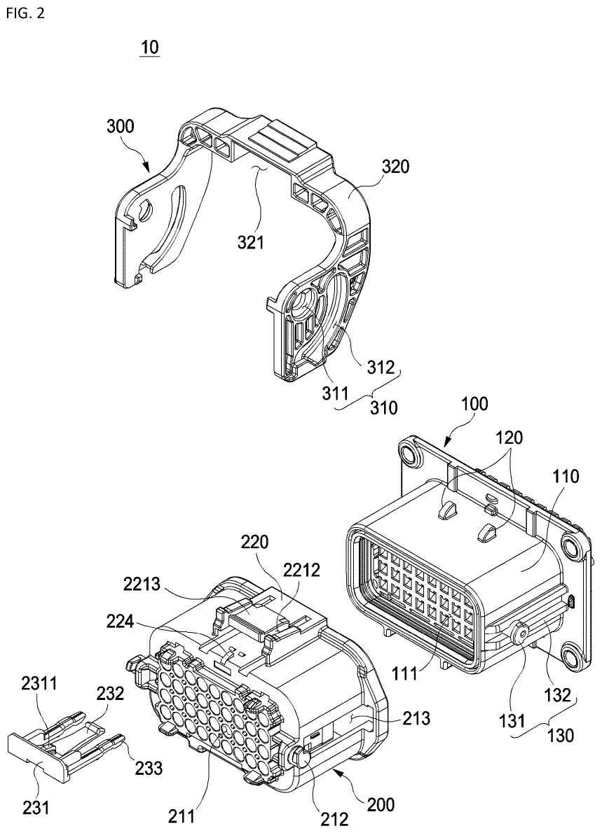

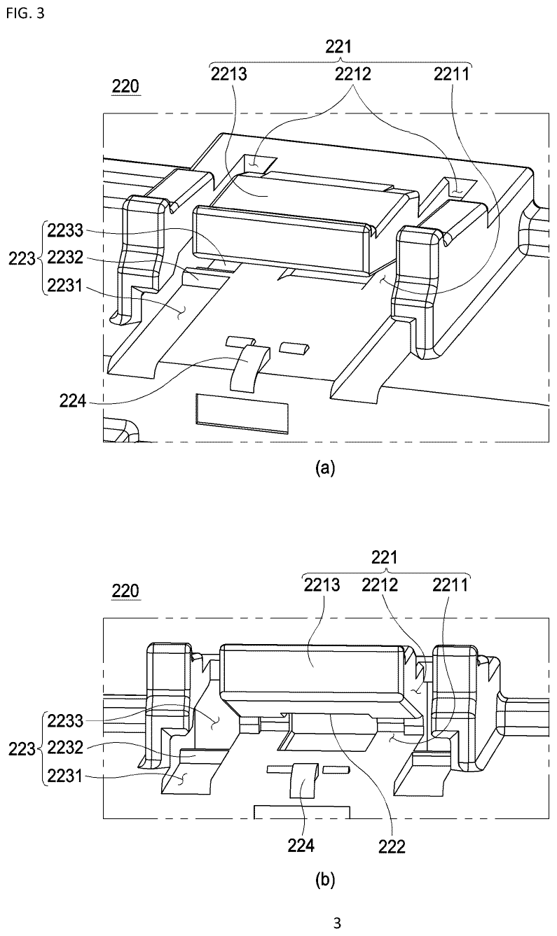

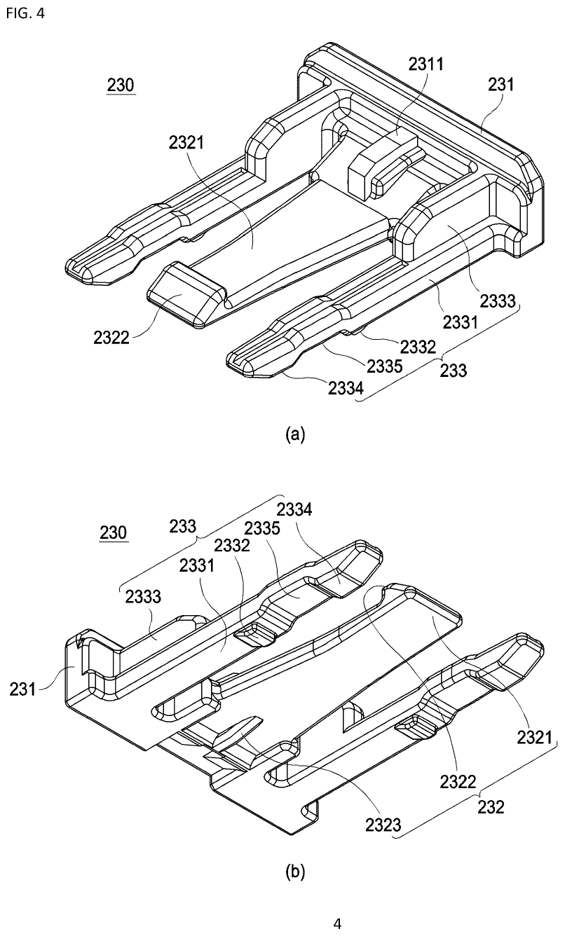

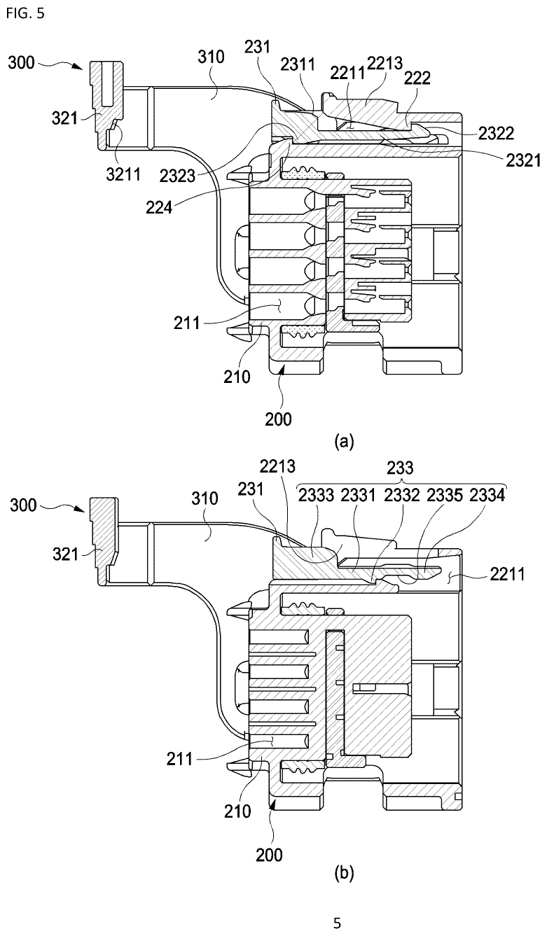

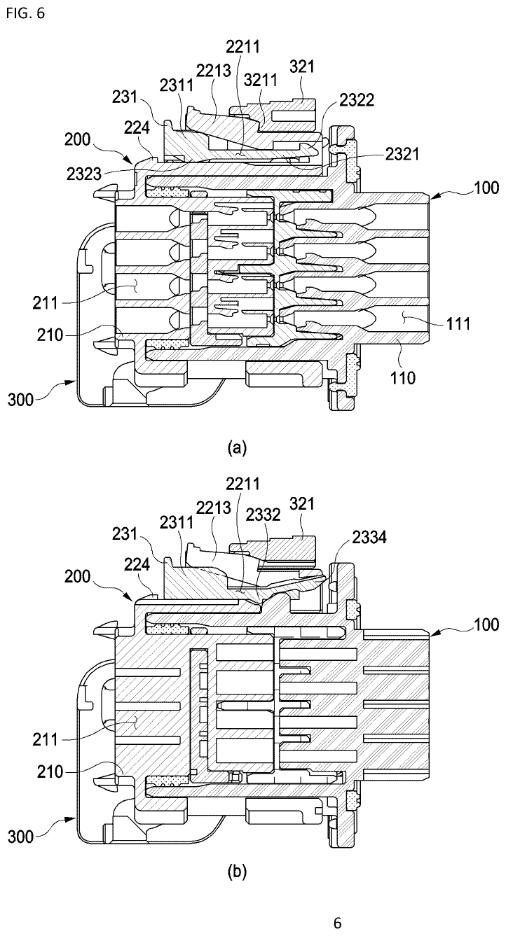

FIG. 1 is a perspective view of a connector according to an embodiment of the present invention; FIG. 2 is an exploded perspective view of FIG. 1; FIG. 3(a) is an enlarged view of part A in FIG. 2, and FIG. 3(b) is a perspective view of FIG. 3(a) from another direction; FIG. 4(a) is a perspective view of the locking member in FIG. 2 from another direction, and FIG. 4(b) is a further perspective view of FIG. 4(a); FIG. 5(a) is a cross-sectional view taken along line Va-Va in a state where the locking member in FIG. 2 is temporarily fixed to the second connector, and FIG. 5(b) is a cross-sectional view taken along line Vb-Vb in a state where the locking member in FIG. 2 is temporarily fixed to the second connector; and FIG. 6(a) is a cross-sectional view taken along line VIa-VIa of FIG. 1, and FIG. 6(b) is a cross-sectional view taken along line VIb-VIb of FIG. 1.

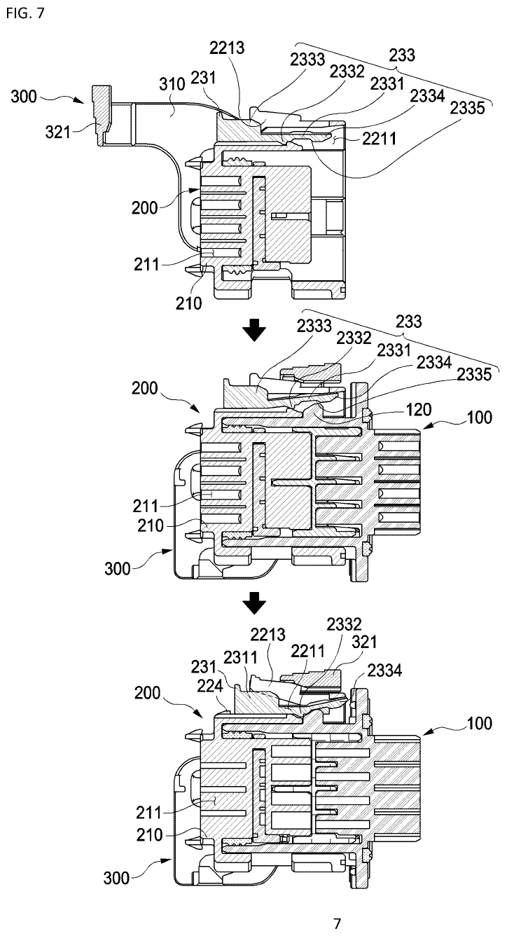

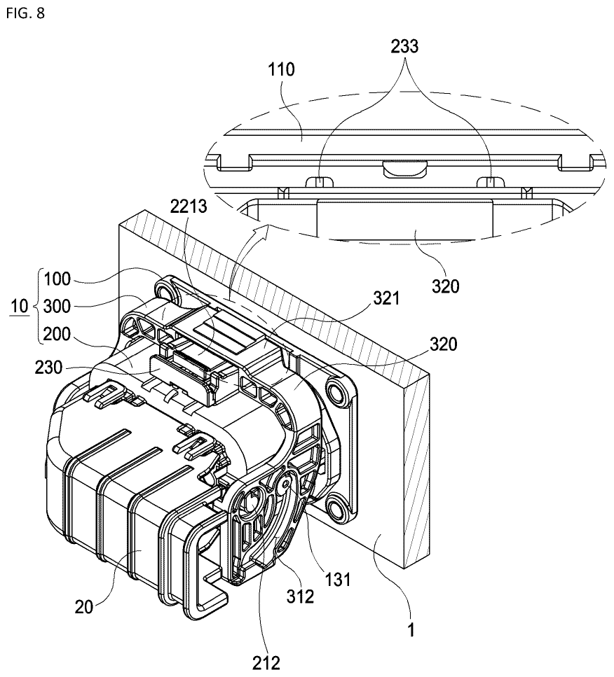

FIG. 7 is a diagram illustrating the process in which FIG. 4(b) changes to FIG. 5(b) as the first and second connectors in FIG. 2 are coupled; and FIG. 8 is a perspective view showing the connector of FIG. 1 in a state coupled to a vehicle body.

Referring to FIGS. 1 to 8, a connector (10) according to an embodiment of the present invention comprises a first connector in which a first terminal is installed inside; a second connector in which a second terminal electrically connected to the first terminal is installed inside; and a fastening lever movably installed on the outer side of the second connector to guide complete fastening with the first connector, wherein the second connector includes a second connector body in which a locking portion is formed on the outer side and the second terminal is received on the inner side, and a locking member temporarily fixed to the locking portion and, when the fastening lever is moved and the first and second connectors are completely fastened, moved to be latched and fixed to the first connector, thereby preventing separation of the second connector.

The first connector (100) includes a first connector body (110) in which a receiving space (111) opened in the coupling direction is formed; a prevention projection (120) that protrudes in the axial direction from the first connector body (110) to unlatch a second contact projection; and a connection guide portion (130) that moves the second connector (200) in the coupling direction according to the movement of the fastening lever (300) to couple it with the first connector (100).

In this case, the receiving space (111) is partitioned such that a plurality of first terminals are respectively received; and the connection guide portion (130) includes a connection guide projection (131) that passes through the second connector body (210) and is seated on a rotary guide line (312), and a connection guide line (132) that moves the second connector (200) in the coupling direction as the connection guide projection (131) moves along the rotary guide line (312).

Accordingly, the first connector (100) is coupled with the second connector (200) as the fastening lever (300) rotates, and the rotational distance of the fastening lever (300) is formed to be longer than the coupling distance of the first and second connectors (100, 200), so that a worker can couple the first and second connectors (100, 200) with less force.

The second connector (200) includes the second connector body (210) in which a connection space (211) opened in the coupling direction is formed; a locking portion (220) formed outwardly from the second connector body (210); and a locking member (230) inserted into the locking portion (220) to prevent the release of the first and second connectors (100, 200), thereby being stably coupled to the first connector (100) formed on the vehicle body.

In this configuration, the connection space (211) is also partitioned so that a plurality of second terminals are respectively accommodated therein, and the plurality of second terminals are electrically connected to the plurality of first terminals by the coupling of the first and second connectors (100, 200) to form a plurality of circuits; the second connector body includes a rotation projection (212) seated in the rotational center hole (311) of the fastening lever (300), and an interlocking hole (213) formed through the second connector body (210) so that the connection guide projection (131) is seated in the rotary guide line (312).

In summary, the fastening lever (300) rotates about the rotation projection (212) formed on the second connector body (210), and the connection guide projection (131) formed on the first connector body (110) is seated in the rotary guide line (312) through the interlocking hole (213), so that the first and second connectors (100, 200) are moved in the coupling direction and coupled in conjunction with the rotation of the fastening lever (300).

The locking portion (220) includes a locking body (231) formed on one side of the second connector body (210), a first temporary fixing portion (222) in which a first locking rib (232) is latched and fixed, and a second temporary fixing portion (223) in which the second locking rib (233) is latched and fixed, thereby allowing the locking member (230) to be maintained in a temporarily fixed state to the locking portion (220).

Accordingly, the locking member (230), in a temporarily fixed state, can be transported together with the second connector body (210), so that the worker can stably fix the first and second connectors (100, 200) simply by completely fastening the locking member (230), thereby significantly reducing work fatigue.

To this end, a movable space (2211) is formed on the inner side of the locking body (231) so that the locking member (230) can move a predetermined distance in the coupling direction; in this configuration, the movable space (2211) is open in the coupling direction, so that the second locking rib (233) is exposed to the outside of the locking body (231) when the locking member (230) is completely fastened, thereby allowing the worker to visually check whether the locking member (230) is completely fastened.

In addition, the locking portion (220) includes a pair of slit lines (2212) formed in parallel in the coupling direction and a deformation support portion (2213) having a cantilever-like shape that is elastically deformable in the axial direction between the slit lines (2212), so that the deformation support portion (2213) is tightly fixed to one side of the fastening lever (300) when the locking member (230) is completely fastened.

This is to provide axial fixation force in a state where the first and second connectors (100, 200) are coupled, that is, where the fastening lever (300) is rotated, thereby preventing the fastening lever (300) from being unintentionally released; a support step (2214), which has a different height in the axial direction, is formed on the outer side of the deformation support portion (2213), and a tight contact step (3211), having a complementary structure to the support step (2214), is formed on the fastening lever (300), thereby also providing fixation force in the coupling direction.

The first temporary fixing portion (222) is formed to protrude into the movable space (2211) such that the first locking rib (232) is latched and fixed on one side in the coupling direction, and the second temporary fixing portion (223) is formed to protrude into the movable space (2211) such that the second locking rib (233) is latched and fixed on the other side in the coupling direction, thereby preventing the locking member (230) from being released forward or rearward in the coupling direction while in the temporarily fixed state.

In this configuration, the latching between the second temporary fixing portion (223) and the second locking rib (233) is released by the coupling with the first connector (100); as it includes a guide groove (2231) that guides the temporary fixing position and movement in the coupling direction of the second locking rib (233), a second temporary fixing projection (2232) formed at the end of the guide groove (2231) and protruding into the movable space (2211), and a guide line (2233) that receives the prevention projection (120) into the movable space (2211) so as to release the latching of the second locking rib (233).

In this configuration, the first temporary fixing portion (222) and the second temporary fixing portion (223) are formed on different surfaces so as to face each other, thereby preventing interference with the first locking rib (232) when the prevention projection (120) elastically deforms and releases the second locking rib (233).

In one embodiment, the locking member (230) includes a pair of second locking ribs (233); to supplement the fixing force on one side in the coupling direction, it is preferable that the locking portion (220) further includes a third temporary fixing portion (224), to which the first locking rib (232) is latched and fixed on one side in the coupling direction at a position different from that of the pair of second locking ribs (233).

The locking member (230) is formed with the locking body (231) disposed at the outer front of the movable space (2211), and first and second locking ribs (232, 233) that are temporarily fixed by being latched and fixed in the coupling direction, so as to be held in a temporarily fixed state in the locking portion (220); however, upon coupling of the first and second connectors (100, 200), the latching on one side in the coupling direction,—that is, the rear—is released, and the locking member moves along the movable space (2211) to fix the fastening lever (300).

To this end, a deformation inducing portion (2311) protruding in the axial direction is formed on one side of the locking body (231), so as to elastically deform the deformation support portion (2213) in the axial direction and allow the support step (2214) and the tight contact step (3211) to come into complementary tight contact; accordingly, when the locking member (230) is completely fastened, the fastening lever (300) is prevented from rotating backward, thereby ultimately preventing the first and second connectors (100, 200) from being unintentionally released.

Specifically, the first locking rib (232) includes a first locking body (2321) extending in the coupling direction; a first locking projection (2322) protruding in the axial direction at the rear end of the first locking body (2321) and latched and fixed to the first temporary fixing portion (222); and a reinforcing projection (2323) protruding in the axial direction at the front end of the first locking body (2321), that is, the portion connected to the locking body (231), and latched and fixed to the third temporary fixing portion (224).

In this configuration, it is preferable that the first locking projection (2322) and the reinforcing projection (2323) are respectively formed on opposing surfaces of the first locking body so as to provide improved fixing force; accordingly, the movement of the locking member (230) toward the front in the coupling direction is restricted.

The second locking rib (233) includes a second locking body (2331) extending in the coupling direction, a second locking projection (2332) protruding in the axial direction from one surface of the first locking body (2321) and latched and fixed to the second temporary fixing portion (223), a guide projection (2333) protruding in the axial direction from one surface of the first locking body (2321) and seated in the slit line (2212), and an interlocking portion (2334) protruding in the axial direction from the rear end of the first locking body (2321) and moved along the outer circumferential surface of the prevention projection (120).

In this configuration, at the front of the interlocking portion (2334), a contact groove (2335) is formed in which the prevention projection (120) is seated when the locking member (230) is in the completely fastened state; when the second temporary fixing portion (223) and the second locking projection (2332) are in an unlatched state, they each have an inclined surface that is inclined in the same direction and come into contact with each other, thereby preventing being released from the completely fastened position.

However, since the contact groove (2335) and the prevention projection (120), and the inclined surface of the second temporary fixing portion (223) and the inclined surface of the second locking projection (2332) do not form respective structures in which they are latched and fixed to each other, the worker can pull the locking member (230) with a force exceeding a certain threshold to return it to the temporarily fixed position, accordingly the fastening lever (300) can be rotated in the reverse direction to release the first and second connectors (100, 200).

In summary, the locking member (230) includes first and second locking ribs (232, 233) that are latched and fixed in the coupling direction to restrict movement in the front and rear directions; and, when the first and second connectors (100, 200) are coupled, the latching of the second locking rib (233) is released by the prevention projection (120), allowing it to move rearward in the coupling direction, and at that time, the deformation inducing portion (2311) causes the deformation support portion (2213) to come into tight contact with the fastening lever (300), thereby preventing reverse rotation.

To this end, in one embodiment, the locking member (230) includes the first locking rib (232) formed at the center of the locking body (231), and the pair of second locking ribs (233) formed on both sides of the first locking rib (232), thereby enhancing fixing force in the temporarily fixed state; and, when coupled with the first connector (100), the pair of second locking ribs (233) are released, which significantly reduces the insertion force of the locking member (230) and reduces the worker's fatigue.

Accordingly, in one embodiment, the prevention projection (120) is also formed as a pair, and the second temporary fixing portion (223), which are latched and fixed to the second locking ribs (233), are likewise formed as a pair, so that the locking member (230) can be stably displaced from the temporarily fixed position to the completely fastened position.

Accordingly, the connector (10) of the present invention discloses a novel structure that can significantly reduce the insertion force of the locking member (230) while preventing the fastening lever (300) from being unintentionally rotated in reverse, thereby improving workability for the worker and simultaneously preventing unintended release of the connector (10), thus ensuring stability in electrical connection.

The fastening lever (300) includes rotation guide portions (310) and a connecting portion (320); the rotation guide portions are connected to the rotation projection (212), configured to rotate about the rotation projection (212), and extend to both sides of the second connector (200), respectively; the connecting portion connects the respective rotation guide portions (310), thereby allowing the worker to easily grip it and enabling the second connector (200) to be stably coupled with the first connector (100).

To this end, the rotation guide portion (310) includes a rotational center hole (311), in which the rotation projection (212) is seated to serve as the rotational axis of the fastening lever (300), and the rotary guide line (312), in which the connection guide projection (131) formed on the first connector (100) is seated to interlock the fastening lever (300) with the first and second connectors (100, 200).

The connecting portion (320) connects the rotary guide portions (310), which can be connected to both sides of the second connector (200), and includes a seating groove (321) recessed at its center to receive the locking portion (220) protruding from the second connector body (210) and a tight contact step (3211) formed on the inner side of the seating groove (321) and having a complementary structure with the support step (2214), so that the fastening lever (300) is stably fixed by the deformation support portion (2213).

As described above, the connector (10) of the present invention is more reliably fixed, as the fastening lever (300), which is involved in the coupling and release of the first connector (100) and the second connector (200), is fixed by coming into surface contact with the deformation support portion (2213) over a certain area.

Accordingly, the first connector (100) and the second connector (200) are also prevented from being unintentionally released, thereby providing stability in electrical connection and further improving the durability and reliability of the product.

While the preferred embodiment of the present invention has been described by way of example above, the scope of the present invention is not limited to such specific embodiments, and appropriate modifications within the scope defined by the claims fall within the protection scope of the present invention.

1. A connector comprising:
a first connector in which a first terminal is installed inside;
a second connector in which a second terminal electrically connected to the first terminal is installed inside; and
a fastening lever movably installed on the outer side of the second connector to guide complete fastening with the first connector,
wherein the second connector includes
a second connector body in which a locking portion is formed on the outer side and the second terminal is received on the inner side, and
a locking member that is temporarily fixed to the locking portion, and that is moved to be latched and fixed to the first connector when the fastening lever is moved and the first and second connectors are completely fastened, thereby preventing separation of the second connector.

2. The connector according to claim 1,
wherein the locking portion is formed with a movable space opened inward in the coupling direction and first and second temporary fixing portions having inclined surfaces in different directions,
and the locking member includes
a first locking rib that is latched and fixed to the first temporary fixing portion and latched and fixed on one side in the coupling direction, and
a second locking rib that is latched and fixed to the second temporary fixing portion and latched and fixed on the other side in the coupling direction, the second locking rib having, at its distal end, an interlocking portion that is released from the second temporary fixing portion by a prevention projection formed on the first connector, moves to the other side in the coupling direction within the movable space, and is latched and fixed on one side of the prevention projection in the coupling direction.

3. The connector according to claim 2,
wherein the second locking rib is formed such that its distal end is exposed to the outside of the locking portion while being latched and fixed to the prevention projection.

4. The connector according to claim 2,
wherein the second connector body further includes a guide line into which the prevention projection is inserted in correspondence with the position of the second temporary fixing portion, and as the first and second connectors are fastened, the interlocking portion is elastically deformed along the outer surface of the prevention projection and released from the second temporary fixing portion.

5. The connector according to claim 2,
wherein the locking portion includes the first temporary fixing portion formed on the inner side and further includes a deformation support portion with slit lines formed on both sides, and
the locking member includes a deformation inducing portion, which, when the locking member is inserted into the movable space, elastically deforms the deformation support portion in the axial direction and tightly fixes it to the fastening lever.

6. The connector according to claim 5,
wherein the second locking rib includes a second locking body, a guide projection protruding from one side of the second locking body and moving along the slit line, a second fixing projection protruding from the other side of the second locking body and latched and fixed to the second temporary fixing portion, and an interlocking portion, all of which are sequentially formed.
